(19) United States
(12) Patent Application Publication
(10) Pub. No.: US 2008/0158447 A1
(43) Pub. Date: Jul. 3, 2008

(54) Projection display device

(75) Inventor: Shuo-Ting Yan, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 12/005,956

(22) Filed: Dec. 28, 2007

(30) Foreign Application Priority Data
Dec. 29, 2006 (TW) 95149702

(51) Int. Cl. G03B 21/20; G02F 1/13

(52) U.S. Cl. 349/5; 353/31

(57) ABSTRACT

An exemplary projection display device (2) includes a color light system (20), a light valve (23), and a projecting structure (25). The color light system is configured for providing different color light beams. The light valve is configured for modulating the color light beams respectively. The projecting structure is configured for projecting the modulated color light beams passing through from the light valve.

### FIELD OF THE INVENTION

The present invention relates to projection display devices, and more particularly to a projection display device capable of modulating red, green, and blue light beams of by a light valve.

### GENERAL BACKGROUND

In recent years, projection display devices have been widely used. From home theaters to business presentations, projection display devices are provided to offer a wide range of functionality to consumers. For example, a projection display device may provide a display of a slide show, a display of a movie in a home theater environment, and so on.

Referring to FIG. 3, a typical projection display device includes a light source 11, a color light system (not labeled), three light valves 131 to 133, a prism unit 14, and a projecting lens 15. The color light system can transfer a white light beam emitted from the light source 11 into a red light beam (R), a green light beam (G), and a blue light beam (B). The prism unit 14 can synthesize the red light beam (R), the green light beam (G), and the blue light beam (B) into a modulated light beam. The projecting lens 15 can project the modulated light beam to a display area.

The color light system includes four reflecting mirrors 1221 to 1224, a red-and-green reflecting dichroic mirror 1251, a green reflecting dichroic mirror 1252, and six condensing lenses 1241 to 1246. The light source 11 provides a white light beam for the reflecting mirror 1221. The white light beam is reflected by the reflecting mirror 1221 and strikes at the red-and-green reflecting dichroic mirror 1251 via the condensing lens 1241 with a 90 degrees bend. Then, a mixture of the red light beam and the green light beam contained in the white light beam is reflected 90 degrees and travels toward the green reflecting dichroic mirror 1252.

The blue light beam passes through the red-and-green reflecting dichroic mirror 1251. The blue light beam is reflected 90 degrees by the reflecting mirror 1222 and passes through the condensing lens 1242 and the light valve 131 to the prism unit 14.

The red light beam and the green light beam traveling toward the green reflecting dichroic mirror 1252 are transferred by the green reflecting dichroic mirror 1252. The green light beam G passes through the green reflecting mirror 1252 and travels toward the reflecting mirror 1223. The red light beam R is reflected 90 degrees and passes through the condensing lens 1243 and the light valve 132 to the prism unit 14.

The green light beam is reflected 90 degrees by the reflecting mirror 1223 and strikes at the reflecting mirror 1224 via the condensing lens 1245. Then the green light beam is reflected 90 degrees by the reflecting mirror 1224 and travels toward the prism unit 14 via the condensing lens 1246 and the light valve 133.

The prism unit 14 synthesizes the red light beam, the green light beam, and the blue light beam into a modulated light beam. The modulated light beam is projected to a projection area by the projecting lens 15, and therefore a color image is displayed within the projection area.

Although the projection display device can project the color light image onto a screen, the projection display device has a complicated projecting optical path. In addition, because three light valve 131 to 133 are used, so that the projection display device 1 is costly and not portable.

What is needed, therefore, is a projection display device that can overcome the above-described deficiencies.

### SUMMARY

An exemplary projection display device includes a color light system, a light valve, and a projecting structure. The color light system is configured for providing different color light beams. The light valve is configured for modulating the color light beams respectively. The projecting structure is configured for projecting the modulated color light beams passing through from the light valve.

Other novel features and advantages will become more apparent from the following detailed description when taken in conjunction with the accompanying drawings.

### BRIEF DESCRIPTION OF THE DRAWINGS

FIG. 1 is an exploded, isometric view of a projection display device according to a first embodiment of the present invention.

FIG. 2 is an exploded, isometric view of a projection display device according to a second embodiment of the present invention.

FIG. 3 is an abbreviate view of a conventional projection display device.

### DETAILED DESCRIPTION OF PREFERRED EMBODIMENTS

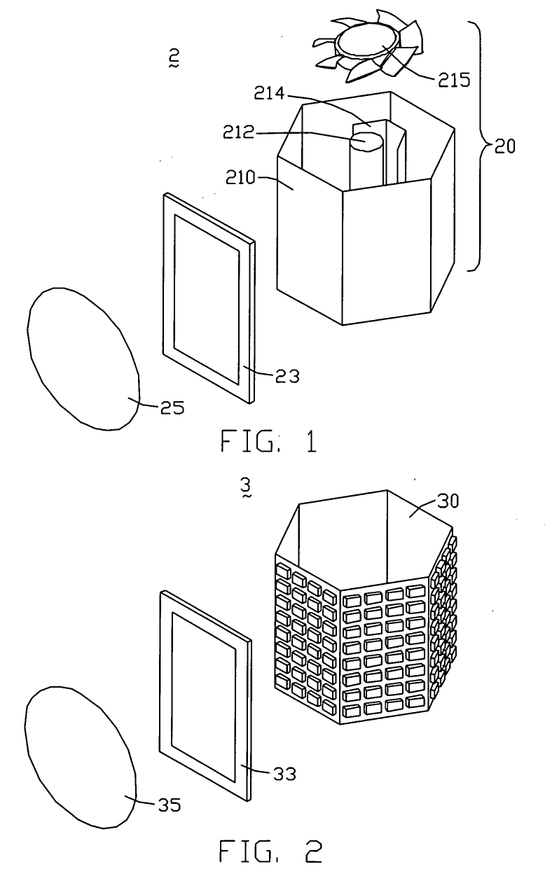

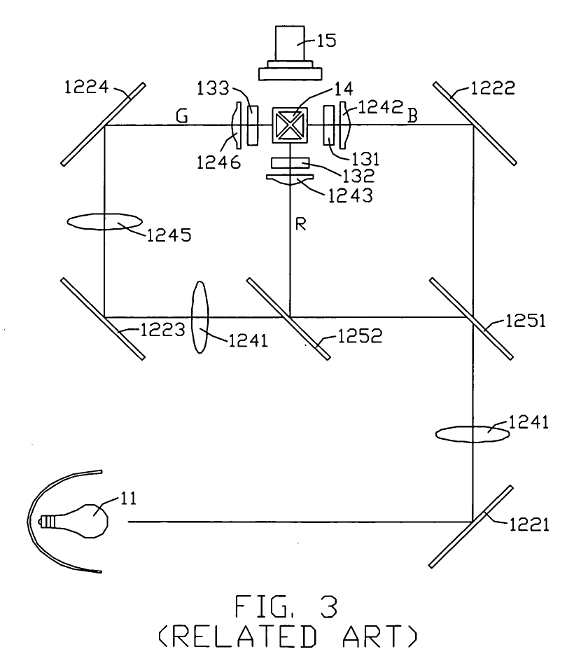

Referring to FIG. 1, an exploded, isometric view of a projection display device 2 according to a first embodiment of the present invention is shown. The projection display device 2 includes a color light system 20, a light valve 23, and a projecting device 25.

The color light system 20 includes a color transferring unit 210 configured for providing a plurality light beams of different colors, a light source 212 configured for providing a plurality white light beams, a reflecting structure 214, and a cooling fan 215.

The color transferring unit 210 includes a plurality of color filters (not labeled). The color filters are connected end-to-end to form a polyhedral enclosure with two opposite regular-polygon openings. The color filters each have a essentially same structure and size. The color filters include a plurality of red (R) filters, a plurality of green (G) filters, and a plurality of blue (B) filters arranged in a sequence of repeating “RGB”. The red filters, the green filters, and the blue filters have the same amount. A total amount of the color filers is a multiple of three.

In the illustrated embodiment, the color transferring unit 210 includes six color filters, which are two red filters, two green filters, and two blue filters arranged in a sequence of “RGBRGB”. The light source 212 is disposed at a central axis of the regular polygon. The light source 212 generally has a long-column shape. The reflecting structure 214 essentially surrounds a half side of the light source 212 opposite to the light valve 23. The light source 212 irradiates white light beams. The reflecting structure 214 is capable of reflecting the white light beams emitted from the light source 212 in a direction generally toward the light valve 23, so that the utilization of the light source 212 can be improved. The cooling fan 215 is adjacent to an end of the light source 212. The cooling fan 215 is configured for exhausting and cooling air current in the color transferring unit 210. The color transferring unit 210 is capable of rotating around the light source 212 so as to filter the white light beams into red, green, or blue light beams.

In general, human's naked eyes can't distinguish between two frames of an animated image when a sum of the frames of the animated image displayed within one second is great enough, or a frame ratio of the animated image is large enough. This is called “visual staying phenomenon”, or “duration of vision”. Normally, in a situation when thirty frames or more are displayed within one second, naked eyes cannot distinguish between two frames and suppose the frames in one second be an animated image. For example, when a preferred 60 frames per second of the animated image display in the projecting screen is required, a certain rotating speed of the color transferring unit 210 is correspondingly determined.

When the projection display device 2 works, the color transferring unit 210 is rotated around the light source 212 at a pre-determined rotative speed. The light source 212 provides white light beams. The white light beam travels to the color transferring unit 210 and passes through one of the red, green, and blue color filters, such that each of the white light beams is filtered into corresponding one of a red light beam, a green color beam and a blue color beam. Because the color transferring unit 210 is rotated, the white light beams are transferred into three-color light beams of red, green, and blue by the color transferring unit 210, respectively. The light valve 23 respectively modulates the red, green, and blue color light beams under control of an exterior circuit. Then, the projecting structure 25 projects the modulated three-color light beams to a prepositioned projecting screen (not shown). In this case, the animated image can be displayed by the projection display device 2 because of “visual staying phenomenon”, as long as the predetermined rotative speed is quick enough.

The light valve 23 can be a liquid crystal panel having no color filters. The liquid crystal panel is preferably in a size of 0.7 inch to a size of 2.2 inch. A response time of the liquid crystal panel is not more than 5 ms (milli second). The light source 212 can be a high intensity discharge lamp (HIDL). The projecting structure 25 can be a convex lens or a group of lenses.

Comparing to the conventional projection display device, the projection display device 2 includes only one light valve 23 and no reflecting mirrors or condensing lens. Thus, the projection display device 2 is more portable and cost-effective.

Referring to FIG. 2, a projection display device 3 according to a second embodiment of the present invention is shown. The projection display device 3 includes a color light system 30, a light valve 33, and a projecting structure 35. The light valve 33 is disposed between the color light system 30 and the projecting structure 35.

The color light system 30 includes a plurality of light walls (not labeled), and a sum of the light walls is a multiple of three. The light walls are connected end-to-end forming an enclosure with two opposite regular polygon shaped openings. Each light wall includes a plurality of illuminators (not labeled) adhered thereon. The illuminators are configured for providing a plurality of light beams of red, or green, or blue. The illuminators of every three successive light walls respectively provide red, green, and blue light beams.

When the projection display device 3 works, the color light system 30 is rotated around a central axis of the regular polygon. The red light beams, green light beams, and blue light beams are respectively emitted and strike to the light valve 33. The light valve 33 modulates the three-color light beams of red, green, and blue. Then the modulated red, green, and blue light beams are projected onto a prepositioned screen by the projecting structure 35. The color light system 310 is rotated quickly enough, thus a viewer observes an animated image because of “visual staying phenomenon”.

The illuminators can be light emitting diodes (LEDs) which can irradiate red, green, and blue light beams respectively. The illuminators can provide three-color light beams invariably. The illuminators can also alternatively provide different color light beams, and only the illuminators of the light wall that straightly faces the light valve 33 irradiate light beams. The illuminator has a light-emitting angle of no more than 30 degrees so as to provide a high concentrating intensity of light beams.

It is to be understood, however, that even though numerous characteristics and advantages of the present embodiments have been set out in the foregoing description, together with details of the structures and functions of the embodiments, the disclosure is illustrative only, and changes may be made in detail, especially in matters of shape, size and arrangement of parts within the principles of the invention to the full extent indicated by the broad general meaning of the terms in which the appended claims are expressed.

What is claimed is:

1. A projection display device comprising:
a color light system configured for providing a plurality of red, green, and blue light beams, the color light system having a polyhedral enclosure shape and being capable of rotating around a central axis of the enclosure, the red, green, and blue light beams being provided sequentially through the rotating of the color light system;
a light valve configured for modulating the red, green, and blue light beams respectively under control of an exterior circuit; and
a projecting structure configured for projecting the modulated color light beams onto a prepositioned display region.

2. The projection display device in claim 1, wherein the color light system comprising a color transferring unit and a light source configured for providing a plurality of white light beams, the color transferring unit being configured for transferring the white color beams into the red, green, and blue color light beams, the light source being disposed at the central axis of the enclosure.

3. The projection display device in claim 2, wherein the color transferring unit comprises a plurality of red filters, a plurality of green filters, and a plurality of blue filters connected end to end according to a sequence of repeat of red-green-blue, and the polyhedral enclosure is formed thereof.

4. The projection display device in claim 3, wherein the red filters, the green filters, and the blue filters have the same amount.

5. The projection display device in claim 4, wherein the red, green, and blue filters are same in size.

6. The projection display device in claim 3, wherein the light source has a column shape.

7. The projection display device in claim 3, wherein the color light system further comprises a reflecting structure disposed adjacent to the light source, the reflecting structure surrounding a half side of the light source opposite to the light valve.

8. The projection display device in claim 3, wherein the color light system further comprises a cooling fan, the cooling fan being disposed adjacent to an end of the light source.

9. The projection display device in claim 2, wherein the light valve is a liquid crystal panel without color filters.

10. The projection display device in claim 1, wherein the color light system comprising a plurality of light walls connected end to end forming a polyhedral enclosure thereof, the light walls being configured for providing red light beams, green light beams, and blue light beams respectively.

11. The projection display device in claim 10, wherein each of light walls comprises a plurality of illuminators.

12. The projection display device in claim 10, wherein every three successive light walls provide red light beams, green light beams, and blue light beams respectively.

13. The projection display device in claim 11, wherein the illuminators comprise a plurality of red light emitting diodes, a plurality of green light emitting diodes, and a plurality of blue light emitting diodes, the red, green, and blue light emitting diodes being respectively disposed at three successive light walls.

14. The projection display device in claim 13, wherein a sum of the light walls is a multiple of three.

15. The projection display device in claim 10, wherein the projecting structure is a convex lens.

16. The projection display device in claim 10, wherein the projecting structure is a group of lenses.

17. The projection display device in claim 10, wherein the light valve is a liquid crystal having no color filters.

18. The projection display device in claim 10, wherein the polyhedral enclosure has two opposite openings and is capable of rotating around a central axis of the enclosure.

19. A projection display device comprising:
a color light system configured for providing different color light beams in sequentially through rotating;
a light valve configured for modulating the color light beams respectively; and
a projecting structure configured for projecting the modulated color light beams passing through from the light valve to display images.
